(19) United States
(12) Patent Application Publication
(10) Pub. No.: US 2025/0206882 A1
(43) Pub. Date: Jun. 26, 2025

(54) Polyamide 56 Composition with Reduced Moisture Absorption

(71) Applicant: TE Connectivity Solutions GmbH, Schaffhausen (CH)

(72) Inventors: Qi AN, Fremont, CA (US); Lei WANG, San Jose, CA (US); Dejie TAO, Fremont, CA (US); Megan Hoarfrost BEERS, Redwood City, CA (US)

(73) Assignee: TE Connectivity Solutions GmbH, Schaffhausen (CH)

(21) Appl. No.: 18/393,821

(22) Filed: Dec. 22, 2023

(51) Int. Cl. C08G 69/26; C08F 222/10; C08J 3/24; C08J 3/28; C08K 5/3492

(52) U.S. Cl. CPC C08G 69/26; C08F 222/103; C08J 3/243; C08J 3/28; C08K 5/34924; C08J 2377/06

(57) ABSTRACT

A polyamide 56 composition with reduced moisture absorption is disclosed. The polyamide 56 composition comprises polyamide 56, and a crosslinking agent. The crosslinking agent is triallyl isocyanurate. The polyamide 56 composition can then be further subject to radiation crosslinking.

### FIELD OF THE INVENTION

The present invention relates to a polyamide 56 composition with reduced moisture absorption. In particular, the invention is directed to a polyamide 56 composition comprising a polyamide 56 and a crosslinking agent. The polyamide 56 composition is crosslinked using electron beam radiation. The resulting polyamide composition has reduced moisture absorption as compared to a polyamide 56 without a crosslinking agent.

### BACKGROUND OF THE INVENTION

Polyamides are some of the most widely used thermoplastic materials due to their physical characteristics. Polyamides are semi-crystalline polymers produced by the condensation of a diacid and diamine. They have good abrasion and wear resistance, as well as high chemical and corrosion resistance. Polyamides have flexibility and low density in addition to ultraviolet resistance. In light of these characteristics, polyamides play an important role in many automotive, electrical, and consumer goods applications.

Notwithstanding the beneficial properties of polyamides, many polyamides have a shortcoming with moisture absorption. Moisture absorption may cause loss in tensile strength and modulus due to the interaction of moisture with the polyamide polymer chain. A product made from polyamide may also have a loss of electrical performance and dimensional stability due to moisture absorption.

Pramanik et. al., in an article “Radiation Processing of Nylon 6 by e-beam for improved properties”, Radiation Physics and Chemistry 78 (2009) 199-205, describe the limitations of the use of Nylon 6 (a polyamide) due to undesirable water absorption and insufficient strength properties. Pramanik et. al. describes irradiating Nylon 6 by electron beam radiation in the presence of triallyl isocyanurate. The article describes that the hardness, tensile strength, flexural strength of the Nylon 6 were improved, while the amount of water absorption was reduced upon being exposed to electron beam radiation.

In a later article published in 2011, Pramanik et. al. describe how Nylon 66 was transformed into a material with improved hardness, tensile strength and flexural modulus by processing the material under an optimized dose of electron beam radiation in the presence of a crosslinking agent. See, “Modification of Nylon 66 by Electron Beam Irradiation for Improved Properties and Superior Performances”, Journal of Applied Polymer Science, Vol. 122, Issue 1 (193-202). As a result of their investigation, Pramanik et. al., concluded that thermogravimetric analysis revealed that the thermal stability of the material improved with radiation. The researchers concluded that improvement in the physical properties, as well as reduction of the water absorption of the material, was due to the crosslinking of the polyamide molecules.

In the paper, “Development of an Advanced Engineering Polymer from the Modification of Nylon 66 by e-Beam Irradiation”, Defence Science Journal, Vol. 64, No. 3, May 2014, pp. 281-289, Pramanik et. al., describe the irradiation of Nylon 66 in the presence of polyurethane, an impact modifier, in combination with triallyl isocyanurate as a crosslinking agent, which resulted in significant improvement of hardness, tensile strength, flexural modulus, impact strength as well as a reduction in percent water absorption by the Nylon 66. The authors speculated that the increase in dimensional stability may be attributed to the decrease in crystallinity of the Nylon 66 polymer.

Pramanik et. al, in 2021 published another paper: “E-beam Induced Crosslinking of Highly Crystalline Nylon 6: Optimization of Triallyl Isocyanuarate Concentration”, Radiation Physics and Chemistry, Vol. 187, October 2021. In this paper, Pramanik et al. reported that the optimization of triallyl isocyanurate concentration resulted in further improvement of the Nylon 6 properties subject to electron beam radiation. The authors concluded that the introduction of the triallyl isocyanurate and the electron beam radiation disturbed the crystallinity of the Nylon 6 matrix, and hence caused enhanced crosslinking. As a result, they observed a significant decrease in water absorption of the polymer.

Ovsik et. al, in “Influence of Cross-Linking Agent Concentration/Beta Radiation Surface Modification on the Micro-Mechanical Properties of Polyamide 6”, Materials 2021, 14, 6407, describe their investigation on the effect of electron beam radiation in the doses ranging from 66 to 132 kGy on the micro-mechanical properties of polyamide 6 containing 1, 3, and 5 wt. % of crosslinking agent triallyl isocyanurate. The authors concluded to obtain maximum crosslinking, minimum degradation and highest increase of indentation hardness and modulus, polyamide 6 had to contain either 3 or 5 wt. % of triallyl isocyanurate and be irradiated by 132 kGy.

As many polyamides are made from fossil fuels which emit carbon dioxide and contribute to global warming, there has been an increased attempt to use bio-based polyamides. Examples of bio-based polyamides include but are not limited to polyamide 56 and polyamide 1010. However, many of these bio-based polyamides suffer from increased water absorption as compared to conventional polyamides such as polyamide 6 or polyamide 66. The increased water absorption results in loss of dimensional stability of the product formed from the bio-based polyamide as well as a potential loss of electrical performance.

Gan et al., in “The Investigation of Copolymer Composition Sequence on Non-Isothermal Crystallization Kinetics of Bio-Based Polyamide 56/512, Polymers 2023, 15, 2345, copolymerized bio-based polyamide 56 with polyamide 512 using melt polymerization. The authors used this approach to see if the low toughness and high water absorption of pure polyamide 56 could be improved. Through thermogravimetric analysis, the authors found that the thermal stability of the polyamide 56/polyamide 512 increased with an increasing proportion of the polyamide 512 added to the composite.

He et. al, “Achieving Anti-moisture Absorption and High Thermal Properties in Bio-based Polyamide 56/F-based Heat-Resistant Agent Composites through Crystal Regulation”, Journal of Applied Polymer Science, Vol. 140, Issue 34 (23 Jun. 2023), describe their study on polyamide 56. The anti-moisture absorption and thermal properties of polyamide 56 were improved by adding heat-resistant agents to expand the application of polyamide 56 in the automotive field. P(N-(4-F-phenylmaleimide)-alt-styrene (PFS) and p (N-(4-pheylmaleimide)-alt-triallyl isocyanurate were used in their study as the heat-resistant agents. With the use of these agents, the anti-moisture absorption increased by 14.6% and 15.5%. The authors attributed this improvement in the anti-moisture absorption due to the crystallization of polyamide 56 with the introduction of the heat-resistant agents.

Thus, there exists a need for a bio-based polyamide composition incorporating polyamide 56 which has reduced water absorption compared to polyamide 56 by itself and which still retains its mechanical properties.

### BRIEF DESCRIPTION OF THE DRAWINGS

The accompanying drawings, which are incorporated into and form a part of the specification, schematically illustrate one or more illustrative embodiments of the invention and, together with the general description given above and detailed description given below, serve to explain the principles of the invention, and wherein:

FIG. 1 is chart showing the dynamic mechanical analysis (DMA) characterization of polyamide 56 and polyamide 56 polymer compositions comprising polyamide 56 and various crosslinking agents.

FIG. 2 (a) is chart showing the comparative analysis of polyamide 66, polyamide 56 and polyamide 56 polymer compositions comprising polyamide 56 and various crosslinking agents for water absorbance using ASTM D570.

FIG. 2(b) is a chart showing the comparative analysis of polyamide 66, polyamide 56, polyamide 56 subject to electron beam radiation and polyamide 56 polymer compositions comprising polyamide 56, and varying amount of the crosslinking agent TAIC and subject to electron beam radiation.

FIG. 3 is chart showing the water absorption uptake for polyamide 66, polyamide 56, polyamide 56 subject to electron beam radiation and polyamide 56 polymer compositions comprising polyamide 56 and varying amount of the crosslinking agent TAIC.

FIGS. 4(a)-4(c) show the comparison of tensile properties of polyamide 66, polyamide 56, polyamide 56 subject to electron beam radiation and polyamide 56 polymer compositions comprising varying amounts of crosslinking agents.

### SUMMARY OF THE INVENTION

An embodiment is directed to a polyamide 56 composition comprising a crosslinking agent.

Another embodiment is directed to a polyamide 56 composition comprising polyamide 56 and a crosslinking agent, wherein said polyamide 56 composition is further subject to radiation

Other features and advantages of the present invention will be apparent from the following more detailed description of the preferred embodiment, taken in conjunction with the accompanying drawings which illustrate, by way of example, the principles of the invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

The polyamide 56 composition of the instant invention comprises a bio-based polyamide. Bio-based polyamides can be produced using polycondensation processes with dioic acids of different chain length. The composition of the invention comprises a polyamide 56. Polyamide 56 is polymerized from bio-based 1,5 diaminoheptane and fossil based adipic acid. Unlike other polyamides, polyamide 56 has a higher moisture absorption due to the higher amide group density and asymmetric chemical structure of the polymer. An example of a commercially available polyamide 56 is ECOBLEND N56F from Shanghai Kumho Sunny Plastics Co., Ltd.

In addition to the polyamide 56, the polyamide 56 composition comprises a crosslinking agent. An example of a crosslinking agent that can be used in the polyamide 56 composition is triallyl isocyanurate (CAS NO Jan. 25, 2015-6). Preferably, the triallyl isocyanurate (TAIC) is added to the polyamide 56 composition in the range of about 0.5 to about 3.0 wt. %. Most preferably, the TAIC comprises 0.5 wt. % of the polyamide 56 composition.

A further example of a crosslinking agent that can be used in the polyamide 56 composition is triallyl cyanurate (TAC) (CAS NO 101-37-1). Preferably, the triallyl cyanurate is added to the polyamide composition in the range of about 0.5 to about 3.0 wt. % of the composition. Most preferably, the TAC comprises 0.5 wt. % of the polyamide 56 composition.

Another example of a crosslinking agent that can be used in the polyamide 56 composition is trimethylopropane trimethacrylate (CAS NO 3290-92-4), a low volatility trifunctional monomer. Such a material is available as SR350 from Sartomer Americas. Preferably, this material is added to the polyamide 56 in the range of about 1 to about 2 wt. %. Most preferably, it comprises 1 wt. % of the polyamide 56 composition.

The polyamide 56 composition can be further subject to crosslinking using radiation. Examples of suitable forms of radiation include but are not limited to ultraviolet radiation, X-ray radiation, gamma radiation and electron beam radiation. The amount of radiation and type of radiation used is dependent upon the specific end properties of the desired final product in order to achieve the desired crosslinking. Preferably, electron beam radiation is used. A product made of the polyamide 56 composition is exposed to electron beam radiation in the range of 50 kGy (5 MRad) to 300 kGy (30 MRad), preferably 75 kGy (7.5 MRad) to 200 kGy (20 MRad) and most prefereably, 100 kGy (10 MRad) to obtain the desired crosslinking.

Other conventional additives may be added to the polyamide 56 composition. Examples of conventional additives include pigments, dyes, voiding agents, antistatic agents, foaming agents, plasticizers, radical scavengers, anti-blocking agents, anti-dust agents, antifouling agents, surface active agents, slip aids, optical brighteners, viscosity modifiers, gloss improvers, dispersion stabilizers, UV stabilizers, UV absorbers, antioxidants such as phenol antioxidants or amine antioxidants, lubricity agents, heat stabilizers, hydrolysis stabilizers, cross-linking activators, coupling agents, layered silicates, radio opacifiers (such as for example, but not limited to, barium sulfate), tungsten metal, non-oxide bismuth salts, colorants, reinforcing agents, adhesion promoters (such as for example, but not limited to, 2-hydroxyethyl-methacrylate-phosphate), impact strength modifiers, and any combination thereof. Such additives may be included in conventional amounts.

In one embodiment, the polyamide 56 is blended using extrusion with the crosslinking agent as well as any other desired additives. The composition is then injection molded to create a desired part. The part is then subjected to radiation by the application of electron beam radiation.

There are many uses for the polyamide 56 composition of the instant invention. For example, the composition can be made into seals, gaskets, connectors, wires, cables, printed wire boards, or EMI shields as well as other electronic or computer components. The composition can be used to make electronic components, such smart phones, general automotive parts, electric motors, e-powertrains, batteries and battery enclosures, chargers for electric vehicles and other components of electric vehicles. In addition, the composition of the instant invention can be used to make molded parts. Furthermore, the polyamide composition of the instant invention can also be used to make medical devices, surgical instruments, medical enclosures or wearable medical devices.

### Examples

Various samples were prepared using ECOBLEND N56F, a polyamide 56, and varying amounts of the crosslinking agents, triallyl isocyanurate and trimethylopropane trimethacrylate (SR 350). The polyamide and various amounts of the crosslinking agents were blended using extrusion. The samples were then injection molded into plaques for moisture analysis or dog bone shaped bars for tensile evaluation. In addition, two additional samples of just the polyamide 56 were molded into plaques. Some of the plaques made from the polyamide 56 polymer itself, as well as polyamide 56 polymer compositions comprising polyamide 56 and varying amounts of TAIC (1 wt. % and 2 wt. % of the total composition), as well as polyamide 56 polymer compositions comprising polyamide 56 and varying amounts of SR350 (1 wt. % and 2 wt. % of the total composition), were then subject to radiation crosslinking by electron beam radiation at a dose of 100 kGy

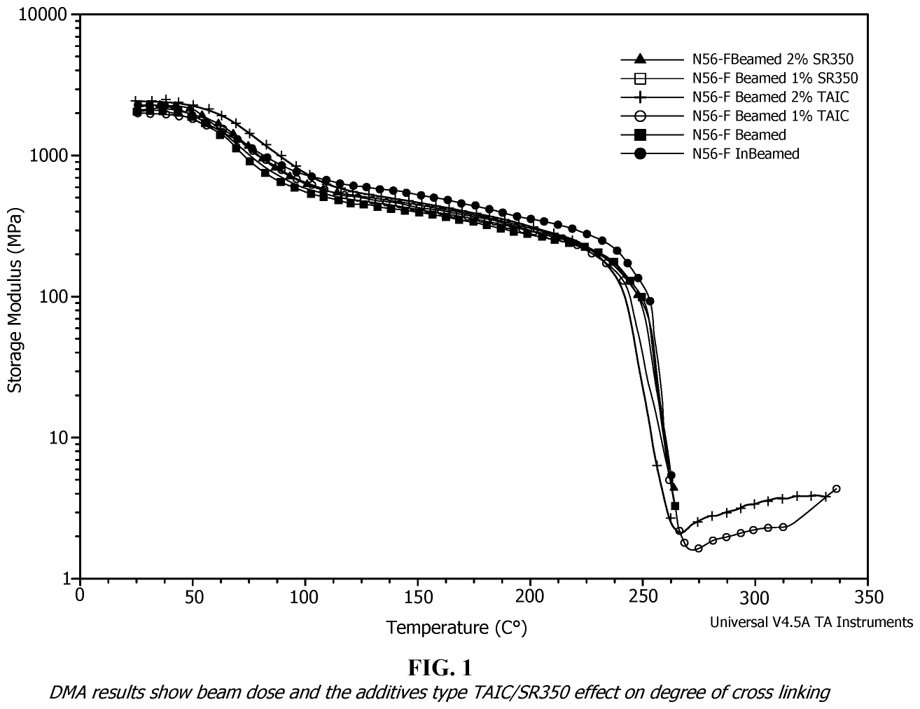

All these samples were subject to DMA characterization using ASTM D4065. FIG. 1 illustrates the results of the DMA characterization. DMA characterization measures storage modulus as a function of temperature. It is believed that the crosslinking agent reduces the distance between polymer chains in the amorphous phase thereby altering the flexibility of the chain and preventing the absorption and ingress of the water molecule in the chain. Based upon these DMA characterization results, using a polyamide 56 composition comprising TAIC as the crosslinking agent which was subject to electron beam radiation showed superior results over the other plaques tested. The plaques with TAIC showed a greater degree of crosslinking than the plaques with SR350 or the polyamide 56 plaque subject to electron beam radiation or the untreated polyamide 56 plaque. Furthermore, plaques with TAIC at 2 wt. % of the total composition showed greater crosslinking than plaques with TAIC at 1 wt. % of the total composition.

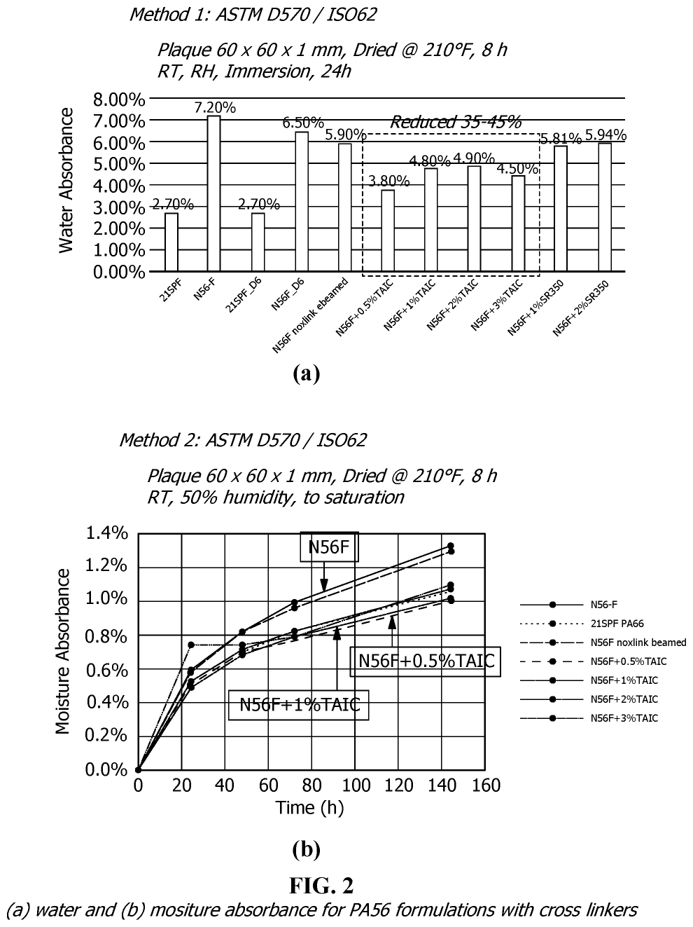

The compositions of the instant invention were also subject to moisture testing in compliance with ASTM D570 (Oct. 12, 2022) and ISO 62:2008. Two different moisture testing procedures were used. In the first method, pre-dried samples (98.9° C., 8 hours) of various compositions measuring 60×60×1 mm were immersed in water at room temperature (approximately 25° C.) for 24 hours. The weight of the samples before and after immersion were noted. The weight increase percentages were calculated for the samples. FIG. 2(a) presents a comparative analysis of absorption of various compositions using the first method. The results clearly show that when polyamide 56 is compounded with a crosslinking agent, the moisture uptake in the polymer composition is decreased. When the polyamide 56 composition with the crosslinking agent is further subject to electron beam radiation, the moisture uptake of the polymer composition was reduced by 15 to 55% in comparison to an untreated polyamide 56 sample; preferably the moisture uptake of the polymer composition was reduced by about 35 to about 45% in comparison to an untreated polyamide 56 sample.

In the second moisture testing method, pre-dried samples (98.9° C., 8 hours) of various compositions measuring 60×60×1 mm were exposed to 50% relative humidity at room temperature until the sample reached saturation as determined when the weight of the sample stopped increasing. The compositions used in this example were polyamide 66, polyamide 56, polyamide 56 subjected to electron beam radiation and polyamide 56 compositions comprising polyamide 56 and varying amounts of TAIC (from 0.5 wt. % to 3.0 wt. % of the total composition). The weight of the samples before and after the test were determined, and weight increase percentages calculated. As seen from FIG. 2(b), the sample made from a composition containing polyamide 56 and 0.5% of TAIC shows the least moisture absorption after 140 hours.

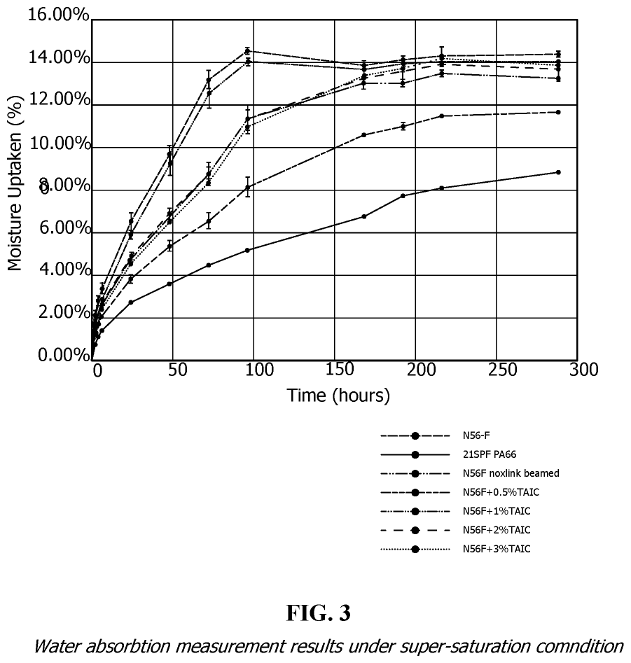

FIG. 3 shows water absorption measurements of various plaques under super-saturation conditions. The plaques used in these examples were 60×60×1 mm. These plaques were exposed to room temperature (about 25° C.) and a room humidity of about 50% for a period of 24 hours. The initial measurements as well as measurements when the sample reached super saturation were taken. Both absolute moisture uptake values and moisture absorption rates were calculated. The absolute moisture uptake values in FIG. 3, show that by including crosslinking agents, the moisture absorption of polyamide 56 is mitigated and the rate of moisture absorption slows down. The composition containing polyamide 56 and 0.5% TAIC subjected to 100 kGy electron beam radiation performed the best based upon these conditions.

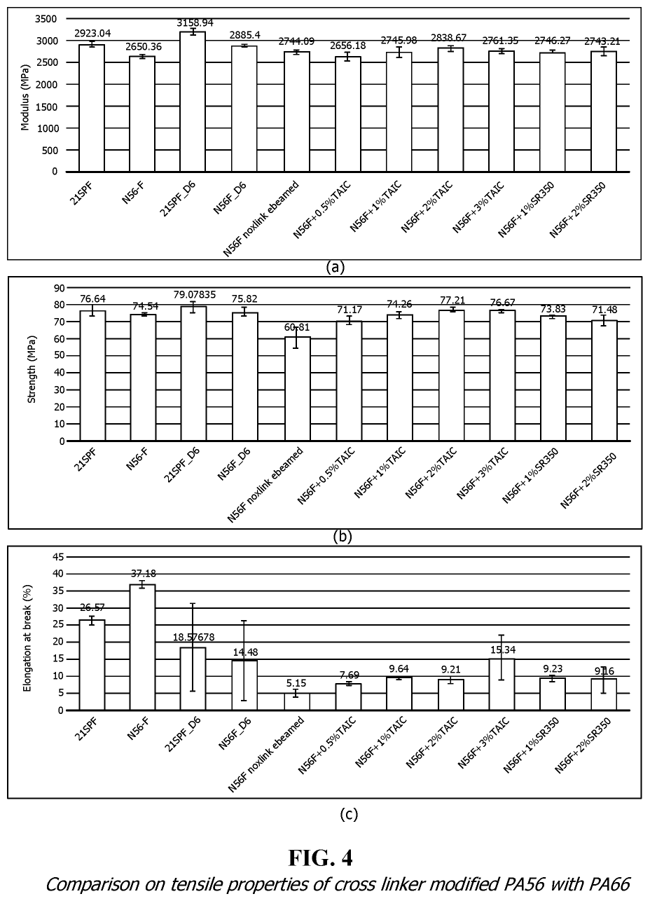

The impact of crosslinking agents on the tensile properties of various compositions were also studied. Plaques of varying compositions were prepared and subject to ASTM D0638-22 (Jul. 21, 2022) conducted at a rate of 5 mm/min using an Instron machine equipped with a 30 kN load cell to determine the impact of using the crosslinking agents. Strain measurements were taken using an extensometer. Compositions comprising polyamide 66, polyamide 56 and various polyamide 56 compositions subject to crosslinking agents were tested under this standard. The results show that the addition of a crosslinking agent renders the polymer composition more brittle as seen by the decrease in the elongation at break of polymer compositions containing crosslinking agents. Nonetheless, the modulus and strength of the polymer composition remained fairly consistent even with the use of the crosslinking agent in the compositions. The results of these various compositions can be seen in FIGS. 4a-4c. These results show that the polymer compositions containing polyamide 56 and crosslinking agents maintained strength and modulus similar to that of polyamide 56 by itself as well as polyamide 66.

One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A polyamide 56 composition comprising a polyamide 56 and a crosslinking agent, wherein said polyamide 56 composition is subject to radiation crosslinking and said polyamide 56 composition has moisture absorption reduced by about 15 to about 55% as compared to a polyamide composition without a crosslinking agent.

2. The composition of claim 1, wherein said crosslinking agent is triallyl isocyanurate.

3. The composition of claim 2, wherein said triallyl isocyanurate is present in the amount of about 0.5 wt. % to about 3 wt. % of the composition.

4. The composition of claim 2, wherein said triallyl isocyanurate is present in the amount of 0.5 wt. % of the composition.

5. The composition of claim 1, further comprising an additional crosslinking agent.

6. The composition of claim 1, wherein said radiation crosslinking is provided in a dose in the range of about 50 kGy to about 300 kGy.

7. The composition of claim 1, wherein said radiation crosslinking is provided in a dose of 100 kGy.

8. The composition of claim 1, wherein said radiation crosslinking is provided in a dose in the range of about 75 kGY to about to 200 kGy.

9. The composition of claim 1, wherein said crosslinking agent is trimethylpropane trimethacrylate.

10. The composition of claim 9, wherein said trimethylpropane trimethacrylate is present in the amount of about 0.5 wt. % to about 3 wt. % of the composition.

11. The composition of claim 9, wherein said trimethylpropane trimethacrylate is present in the amount of 0.5 wt. % of the composition.

12. The composition of claim 9, further comprising an additional crosslinking agent.

13. The composition of claim 12, wherein said composition is subject to radiation crosslinking.

14. The composition of claim 13, wherein said radiation crosslinking is provided in a dose of 100 kGy.

15. A polyamide 56 composition having reduced water absorption comprising a polyamide 56, and a crosslinking agent as compared to a polyamide composition without a crosslinking agent.

16. The polyamide 56 composition of claim 15, wherein said crosslinking agent is chosen from the group comprising triallyl isocyanurate, triallyl cyanurate, and trimethylpropane trimethacrylate.

17. The polyamide 56 composition of claim 15, wherein said polyamide composition is subject to radiation crosslinking.

18. The polyamide 56 composition of claim 17, wherein said radiation crosslinking is provided in a dose of 100 kGy.

19. The polyamide 56 composition of claim 15, wherein said crosslinking agent is triallyl isocyanurate.

20. The polyamide 56 composition of claim 15, wherein said crosslinking agent is trimethylpropane trimethacrylate.
